(19) United States
(12) Patent Application Publication
(10) Pub. No.: US 2009/0141193 A1
(43) Pub. Date: Jun. 4, 2009

(54) IMAGE DISPLAY APPARATUS

(76) Inventors: Kenji NAKAYAMA, Osaka (JP); Kazuhisa YAMAMOTO, Osaka (JP); Tatsuo ITOH, Osaka (JP)

Correspondence Address: WENDEROTH, LIND & PONACK L.L.P., 1030 15th Street, N.W., Suite 400 East, Washington, DC, 20005-1503, US

(21) Appl. No.: 12/256,616

(22) Filed: Oct. 23, 2008

(30) Foreign Application Priority Data
Oct. 25, 2007 (JP) 2007-277320

(51) Int. Cl. H04N 5/74

(52) U.S. Cl. 348/751; 348/E05.137

(57) ABSTRACT

A laser light source 1 outputs a laser. A condenser lens 80 condenses the laser outputted from the laser light source 1, and outputs it to an optical fiber 8. The laser that propagates through the optical fiber 8 enters a light guide panel 2. The light guide panel 2 converts the inputted laser into a planar illumination light. The planar illumination light passes through a light passing control section 4 and illuminates a liquid crystal panel 7, which is a spatial modulation element that convert light into an image. The light passing control section 4 controls a scatter pattern during the passing of the laser individually in each predefined image area, by a control circuit 81. Consequently, an image area 5 in which a speckle noise is reduced and an image area 6 in which the speckle noise is generated, are formed on a liquid crystal panel 7.

### BACKGROUND OF THE INVENTION

1. Field of the Invention

The present invention relates to an image display apparatus that uses a semiconductor laser as a light source.

2. Description of the Background Art

In recent years, there has been research and development of an image display apparatus that uses a semiconductor laser as a light source. The reason behind this is because an image display apparatus with low power consumption may be achieved by using a semiconductor laser as a light source due to a characteristic of the illumination method of semiconductor lasers, which has higher electricity-to-light conversion efficiency than cold-cathode tubes or LEDs.

Power consumption of the image display apparatus will be further reduced by using a semiconductor laser as a light source of the backlight of a liquid crystal display (LCD). A liquid crystal panel in the LCD alters the amount of transmitted light in each pixel by controlling the polarization state of an illuminating light emitted from a planar illumination device. To achieve this, a polarized light from the illuminating light of the LCD is aligned in one direction by passing a polarized filter or the like and becomes a polarized light with a uniform direction. A laser light is generally a linear polarized light by nature. Therefore, the polarized filter can be removed from the LCD, resulting in a higher light utilizing efficiency of the LCD.

Additionally, the laser light outputted from the semiconductor laser generally has a smaller spectrum width compared to a white lamp or a LED, therefore the image display apparatus that uses the semiconductor laser as the light source possesses excellent color reproducibility.

A scanning type image display apparatus that does not require a spatial modulation element has been developed. Elimination of the spatial modulation element was made possible by laser-light-scanning with a two dimensional optical scanning system such as two-dimensional scanning mirrors, and by controlling power of the laser light in accordance with a pixel.

Despite such an advantage, the following problem arises when the semiconductor laser with a small spectrum width is used as the light source of the image display apparatus. A laser light is a coherent light with an aligned phase, and thus has a high coherency. Because of this high coherency, a laser light scattered on an object surface makes a random interference pattern on the viewer's retina, and creates an intensity distribution with a granular glare on an observing surface. This granular intensity distribution is a speckle noise.

Since the speckle noise degrades the image quality of the image display apparatus, research has been done in recent years for a technique to reduce speckle noise to prevent degradation of the image quality.

For example, one proposal is a method for reducing speckle noise by placing a diffusion plate within the light path from a laser light source to the spatial modulation element and vibrating the diffusion plate. Refer (PCT) International Publication WO/2005/008330. This method reduces the speckle noise by averaging out the time integrated interference pattern by changing the interference pattern of the laser light that causes the speckle noise faster beyond the viewer's eye's temporal resolution.

There is also a method that reduces the coherency of the laser light itself. Refer Japanese Laid-Open Patent Publication No. 2007-189520. The semiconductor laser has a characteristic that the wavelength becomes longer when the temperature increases. By using this characteristic and altering the temperature of the semiconductor laser temporally, a laser light with a time integrated larger spectrum width can be created. For example, instead of operating the semiconductor laser continuously, by modulative operation, the temperature of the semiconductor laser can be altered temporally. When the spectrum width of the generated laser light becomes larger, the speckle noise is reduced and the coherency of the laser light becomes weaker.

The speckle noise is a phenomenon specific to laser lights. This can be seen as one function of the image display apparatus that uses a laser light source. A display that uses a light source other than the laser light source does not generate speckle noise; so it is assumed that the speckle noise of the image display apparatus will catch the attention of the viewer. One usage of the speckle noise is to purposely generate speckle noise at a position where one wants the viewer's attention to be on.

A method for applying the speckle noise to an image display apparatus is indicated in, for example, Japanese Laid-Open Patent Publication H05-216119. FIG. 11 is a schematic diagram of an image display apparatus disclosed in this patent Publication. An image is projected from a projector 90 to one side of a semi-transmissive screen 91. On the other side of the semi-transmissive screen 91, a laser light 94 that is outputted by a laser light source 92 is scanned on the semi-transmissive screen 91 by a scanning optical system 93. By scanning the laser light 94 only on a given image area, the speckle noise can be generated only in the given image area.

This method scans and emits laser light on an image without any speckle noises. As a result, this method needs two light sources, one light source for image displaying and another light source for generating the speckle noise, therefore a higher device cost is a problem of this method. Moreover, an objective of the invention according to the Japanese Laid-Open Patent Publication H05-216119 is to high-brightness represent images such as a glare of the sun or a searchlight, and there are no descriptions about images that do not require high-brightness representation. Since the laser light 94 is scanned on an image that was projected by the projector 90, the image area, in which the laser light 94 constantly scanned on, has a higher brightness than the original image without the laser light 94 scanned on.

### SUMMARY OF THE INVENTION

Therefore, an objective of the present invention is to provide an image display apparatus capable of generating a speckle noise in a given image area effectively by using a single laser light source.

The present invention is directed to an image display apparatus that utilizes a speckle noise specific to a laser light, and to achieve this goal, one aspect of a present invention's image display apparatus comprises: a laser light source; a spatial modulation element that converts a laser light outputted from the laser light source into an image; and a light passing control section that controls, in each of a predefined image area, a scatter pattern generated when the laser light passes through.

The light passing control section is a planar device; and a plurality of cells is arranged in a grid pattern; and the plurality of cells is each filled with, a fluid having charged particles dispersed therewithin, a liquid crystal or a fluid having ferromagnetic particles dispersed therewithin; and a voltage or a magnetic field applied to the plurality of cells is individually controlled so that, the scatter pattern is altered in an image area in which the speckle noise is reduced, and the scatter pattern is not altered in an image area in which the speckle noise is generated. In this case, it is preferable if the voltage or the magnetic field is applied in an alteration frequency of 30 Hz or more.

In a displayed image, at least one cell among the plurality of cells is allocated to correspond to a set of neighboring three pixels, these pixels being red, blue and green. When the laser light source comprises three laser light sources, for red, blue and green, respectively; the light passing control section controls the speckle noise only for the green light component.

One aspect of a scanning type image display apparatus of the present invention comprises: a laser light source; a power control section to control the power of a laser light outputted from the laser light source; a scan controlling section that scans the laser light controlled by the power control section and converts the laser light into an image on a projection plane; a light irradiation position control section positioned at a point between the laser light source and the projection plane, which controls the location where the laser light is emitted on the projection plane, individually in a predefined image area.

The light irradiation position control section individually controls the scanned laser light, in away that shifts the center of the emitted laser light for every scan in an image area on the projection plane that is in which the speckle noise is reduced, and in a way that fixes the center of the emitted laser light in an image area on the projection plane that is in which the speckle noise is generated. Furthermore, the scan controlling section may scan the image area in which the speckle noise is generated first, and then scan the image area in which the speckle noise is reduced next, in one screen. When the laser light source comprises three laser light sources, for red, blue and green, respectively; the light irradiation position control section controls the speckle noise only for the green light component.

According to the image display apparatus of the above-described present invention, the speckle noise is efficiently utilized on a given pixel in an image by using a single laser light source.

These and other objectives, features, aspects and advantages of the present invention will be further revealed by the following detailed description in reference to the attached figures.

### BRIEF DESCRIPTION OF THE DRAWINGS

FIG. 1 is a diagram illustrating a configuration of an image display apparatus according to the first embodiment of the present invention;

FIG. 2 is a diagram illustrating a structural example 1 of a cell 4a;

FIG. 3 is a diagram illustrating a structural example 2 of a cell 4a;

FIG. 4 is a diagram of a configurational example that uses a light passing control section 4 in a RPD;

FIG. 5 is a diagram of another configurational example that uses a light passing control section 4 in a RPD;

FIG. 6 is a diagram of a composition of an image display apparatus according to the second embodiment of the present invention;

FIG. 7 is a diagram illustrating a structural example of a light irradiation position control section 49;

FIG. 8 is a diagram of one example of a laser spot position of a pixel unit level on a screen 45;

FIG. 9 is a diagram of one example of one frame displaying an image;

FIG. 10 is a diagram illustrating a method for scanning the one frame in FIG. 9; and

FIG. 11 is a diagram illustrating configurational example of a conventional image display apparatus.

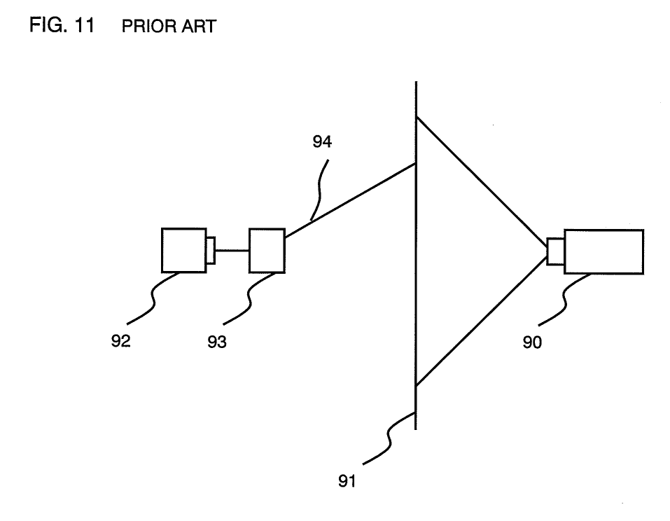

### DESCRIPTION OF THE PREFERRED EMBODIMENTS

Embodiments of the present invention are described in detail with reference to the drawings in the following.

### First Embodiment

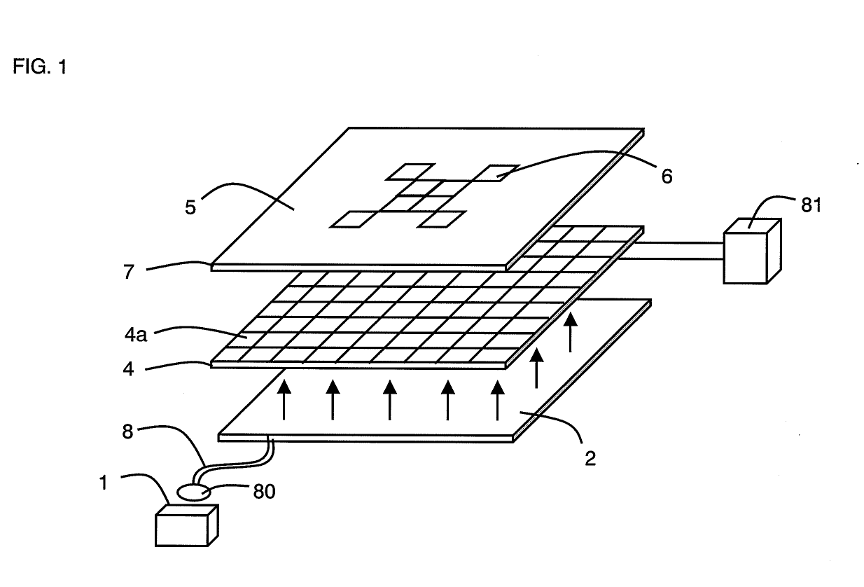

FIG. 1 is a diagram illustrating a configuration of an image display apparatus according to the first embodiment of the present invention. The image display apparatus according to the first embodiment comprises: a laser light source 1; a condenser lens 80; an optical fiber 8; a light guide panel 2; a light passing control section 4; a control circuit 81; and a liquid crystal panel 7.

The laser light source 1 outputs a laser light. The condenser lens 80 condenses the laser light outputted by laser light source 1, and outputs the condensed laser light to the optical fiber 8. The laser light that propagates through the optical fiber 8 is inputted into the light guide panel 2. The light guide panel 2 converts the inputted laser light into a planar illumination light. The planar illumination light passes through the light passing control section 4, and illuminates the liquid crystal panel 7, which is a spatial modulation element that converts light into an image.

By a later described characteristic structure that is adopted, the light passing control section 4 individually controls a scatter pattern obtained during the passing of the laser light in each predefined image areas, under the control of the control circuit 81. More specifically, by the light passing control section 4 and the control circuit 81, an image area 5 in which a speckle noise is reduced and an image area 6 in which the speckle noise is generated, are formed on the liquid crystal panel 7.

The light passing control section 4 is a planar device with a plurality of cells 4a positioned in a grid pattern. The plurality of cells 4a are controlled individually by the control circuit 81, resulting in the alteration of the scatter pattern during passing of the laser light. The following examples may be used as a structure applied in each of the plurality of cells 4a.

### Structural Example 1

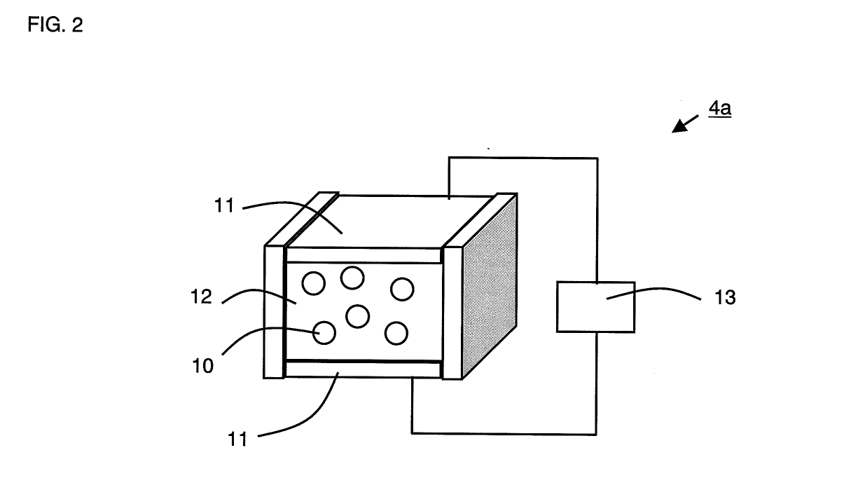

FIG. 2 is a diagram illustrating a structural example 1 of a cell 4a. The structural example 1 of the cell 4a include: a fluid 12 containing a charged particle 10 dispersed within; two electrodes 11 that sandwich the fluid 12 in between; and a voltage applying device 13 to apply voltage to the two electrodes 11. For example, a resin particle of about 10 μm in diameter with a surface coated with oxidized titanium is used as the charged particle 10, and hexane is used as the fluid 12. The voltage-applying device 13 applies voltage between the two electrodes 11 based on an instruction given from the control circuit 81.

The charged particle 10 moves within the fluid 12 in response to the voltage applied between the two electrodes 11. Consequently, if the applied voltage is altered (level, or positive and negative), the charged particle 10 constantly moves within the fluid 12. The scatter pattern of the laser light that passes through the fluid 12 alters temporally when the charged particle 10 is moving within fluid 12. If the scatter pattern is altered temporally, an interference pattern by the laser light can be altered temporally. As a result, the speckle noise can be reduced in the image area 5 on the liquid crystal panel 7 drawn by the laser light that passes through the voltage-applied cell 4a.

On the other hand, when the voltage applied between the two electrodes 11 is constant or when there is no voltage applied between the two electrodes 11, then the scatter pattern of the laser light that passes through fluid 12 does not change temporally and becomes constant since the charged particle 10 does not move within the fluid 12. As a result, the speckle noise can be generated in the image area 6 of the liquid crystal panel 7 drawn by the laser light that passes through the cell 4a which has a constant voltage applied or which does not have any voltage applied.

A liquid crystal may be used instead of the fluid 12 with the charged particle 10 dispersed therein. In this case, a polarization direction of the laser light passing the cell 4a may be controlled in response to the voltage applied in between the two electrodes 11. The speckle noise can be reduced when the polarization direction of the laser light passing the cell is altered from that of a neighboring cell. More specifically, the polarization direction of the laser light becomes random in the image area 5 in which the speckle noise is reduced, while the polarization direction of the laser light becomes constant in the image area 6 in which the speckle noise is generated.

### Structural Example 2

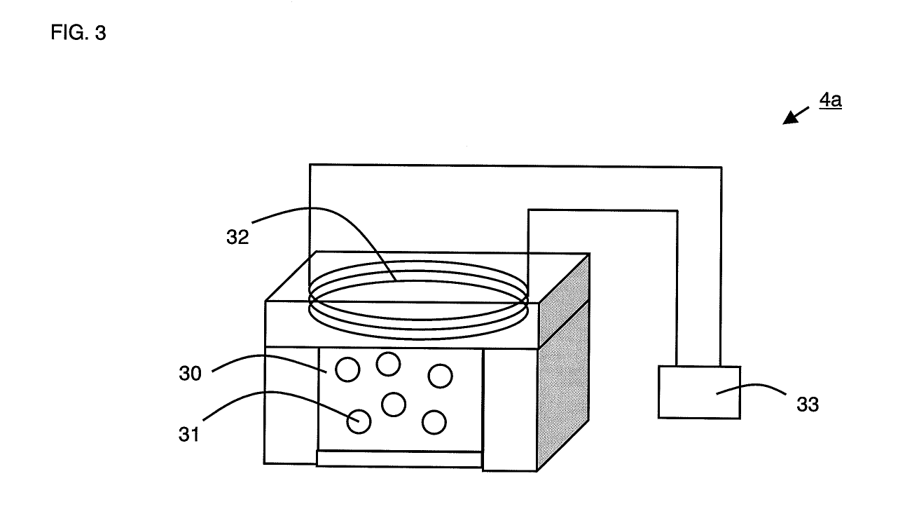

FIG. 3 is a diagram illustrating a structural example 2 of a cell 4a. The cell 4a of the structural example 2 comprises: a fluid 30 containing a ferromagnetic particle 31 dispersed therein; a coil 32 for generating a magnetic field within the fluid 30; and an electrical current providing device 33 to apply an electrical current to the coil 32. The electrical current providing device 33 applies electrical current to the coil 32 based on an instruction given from the control circuit 81.

The ferromagnetic particle 31 moves within the fluid 30 with Brownian motion. Consequently, when the electrical current is not applied to the coil 32 and there are no magnetic fields generated in the cell 4a, the ferromagnetic particle 31 keeps moving within the fluid 30. The scatter pattern of the laser light that passes through the fluid 30 alters temporally when the ferromagnetic particle 31 is moving within the fluid 30. When the scatter pattern is altered temporally, the interference pattern by the laser light can be altered temporally. As a result, the speckle noise can be reduced in the image area 5 drawn on the liquid crystal panel 7 by the laser light that passes through the cell 4a which does not have any electrical currents applied.

On the other hand, when electrical current is applied to the coil 32, a magnetic field is generated in cell 4a and stops the motion of the ferromagnetic particle 31, and the scatter pattern of the laser light that passes through fluid 30 does not change temporally and becomes constant. As a result, the speckle noise can be generated in the image area 6 drawn on the liquid crystal panel 7 by the laser light that passes through the cell 4a which does not have electrical current applied to the coil 32.

In order to make the viewer sufficiently aware of the difference between the speckle noise-reduced image area 5 and the speckle noise-generated image area 6, it is preferable that the alteration frequency of the voltage applied or the generated magnetic field is 30 Hz or more. This is because; the temporal resolution of a human eye is approximately 0.1 second, and when the interference pattern alters three times faster than the temporal resolution of a human eye, the time integrated interference pattern is recognized by the viewer, thus being able to sufficiently reduce the speckle noise of a displayed image.

The number of the plurality of cells 4a may or may not be identical to the number of pixels of the liquid crystal panel 7. In the case of an image display apparatus like a LCD that expresses a white pixel by combining the three red, blue and green pixels together, the plurality of cells 4a in the liquid crystal panel 7 does not have to correspond to each pixel one-to-one. This is because the speckle noise can be sufficiently expressed distinctly by only controlling the reduction/generation of the speckle noise at the white pixel level. Furthermore, when two or more cells correspond to one pixel of the liquid crystal panel 7, the image area 6 that is generating the speckle noise can be expressed with high accuracy, since it becomes possible to include a laser light with two or more polarization components in one pixel.

As describe above, with the image display apparatus of the first embodiment of the present invention, the speckle noise is effectively generated in a given image area by using a single laser light source. As a result, an image that catches attention of the viewer can be displayed easily while maintaining the small size and low cost of the apparatus.

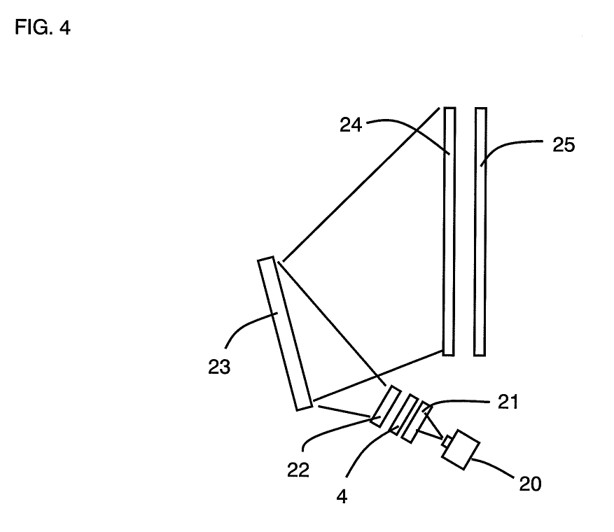

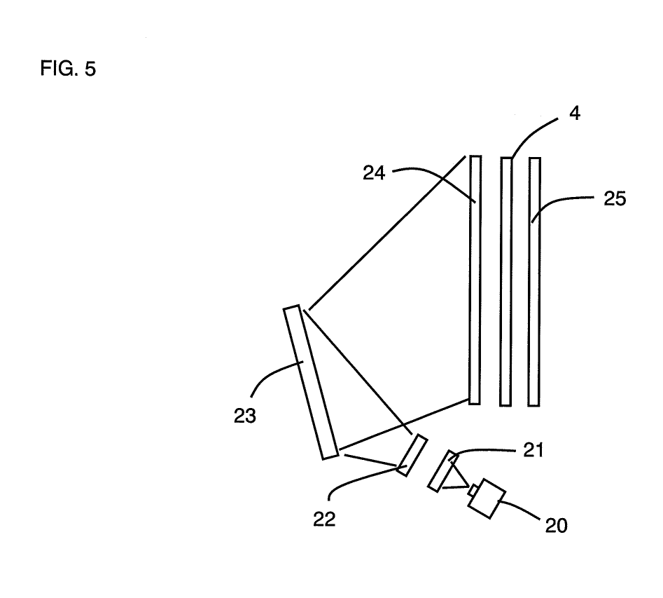

In the case where the light passing control section 4 of the first embodiment is used in a rear projection display (RDP), the positions suited to locate the light passing control section 4 are between the spatial modulation element 21 and an optical system for projecting 22 (FIG. 4), or between a prism sheet 24 and a screen 25 (FIG. 5).

### Second Embodiment

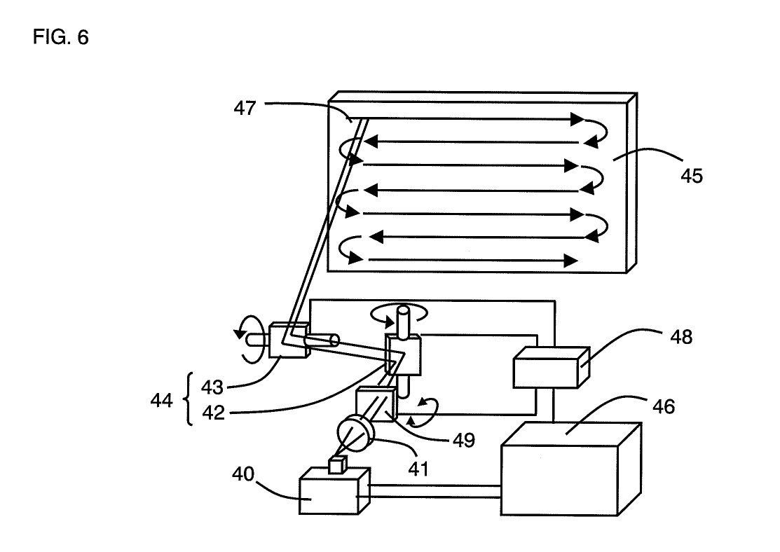

FIG. 6 is a diagram of a composition of a scanning type image display apparatus according to the second embodiment of the present invention. The scanning type image display apparatus according to the second embodiment comprises: a laser light source 40; a collimating lens 41; a scan controlling section 44; a synchronous section 48; a power control section 46; and a light irradiation position control section 49.

The laser light source 40 outputs a laser light with a power based on a control by the power control section 46. The collimating lens 41 converts the laser light outputted by the laser light source 40 into an approximate parallel light. This approximate parallel light passes through the light irradiation position control section 49 and gets inputted into the scan controlling section 44. The scan controlling section 44 includes a horizontal scanning section 42 that horizontally scans the approximate parallel light and a vertical scanning section 43 that vertically scans the approximate parallel light, and converts the approximate parallel light into an image under the control of the synchronous section 48 and projects the image on a screen 45.

By a later described characteristic structure that is adopted, the light irradiation position control section 49 controls an outputted direction (a laser spot position on the screen 45) during the passing of the laser light individually in each predefined image area, under the control of the synchronous section 48. More specifically, by the light irradiation position control section 49 and the synchronous section 48, an image area in which the speckle noise is reduced and an image area in which the speckle noise is generated, are formed on the screen 45.

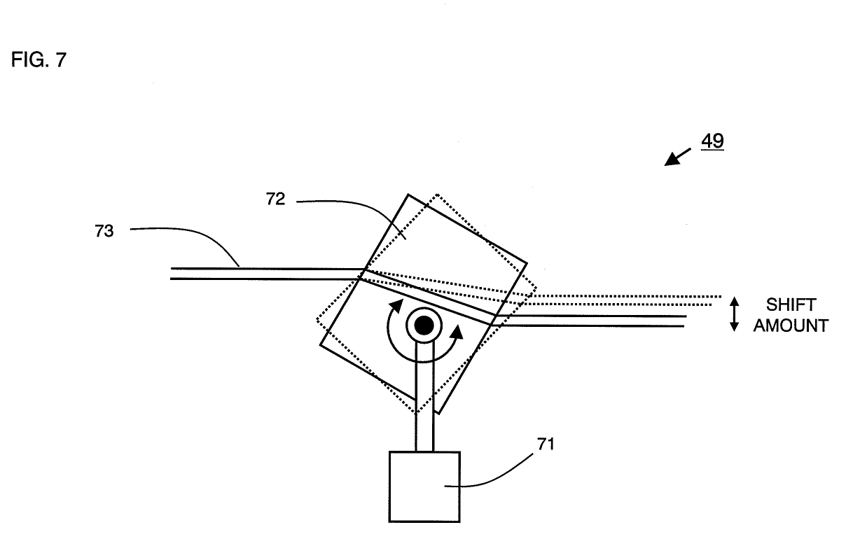

The light irradiation position control section 49 includes for example an actuator 71 and a parallel plate 72 as shown in FIG. 7. The actuator 71 rotates the parallel plate 72 in a predefined angle range. By this rotation, an approximate parallel light 73 (inputted from the left side in FIG. 7) outputted from the collimating lens 41 is outputted out in a shifted direction (outputted from the right side in FIG. 7). The rotation of the actuator 71 is carried out when an image area with reduced speckle noise is scanned, and rotates to a position different from the previous scanned position.

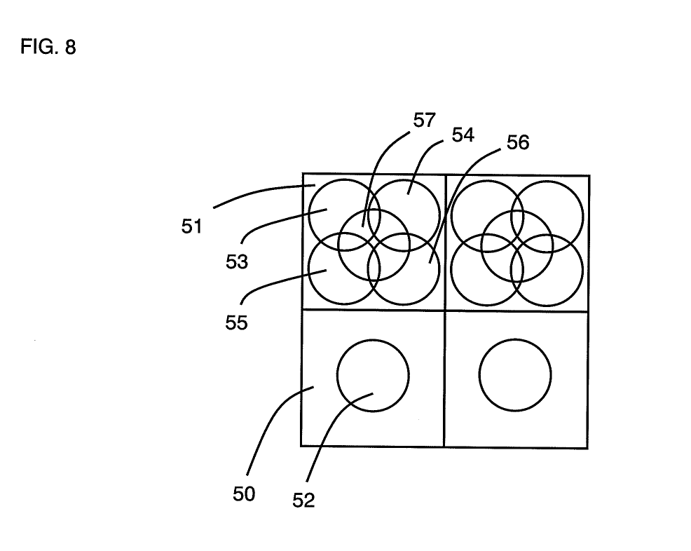

FIG. 8 is a diagram of one example of a laser spot position of a pixel unit level on a screen 45 controlled by the light irradiation position control section 49.

With operation of the light irradiation position control section 49, the laser spot position shifts from position 53 to 57 on each scan in a pixel 51. In this pixel with a shifting laser spot position, a plurality of interference patterns are generated. Since the plurality of averaged interference patterns is recognized by the viewer, the speckle noise at this pixel can be reduced. On the other hand, in a pixel 50, a laser spot position 52 is always constant in each scan. Therefore, one interference pattern is generated and the speckle noise can be generated at this pixel.

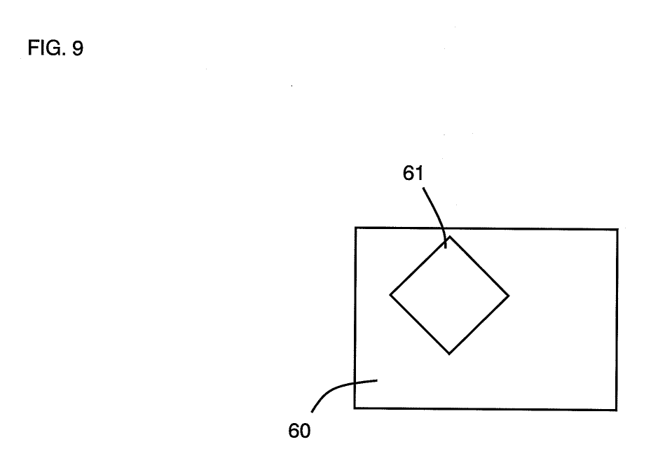

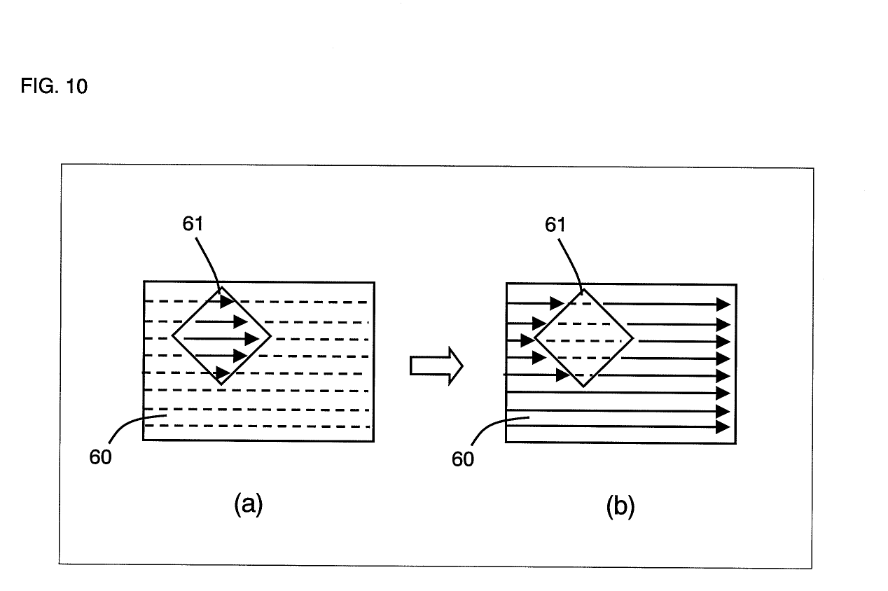

Laser light scanning conducted by the horizontal scanning section 42 and the vertical scanning section 43 do not have to be in series. Take an example as shown in FIG. 9 where an image area 60 in which the speckle noise is reduced and an image area 61 in which the speckle noise is generated co-exist in one frame. In this case, first the image area 61 in which the speckle noise is generated is scanned as a whole without rotating the parallel plate 72 ((a) of FIG. 10). During this time, the laser light source is not lit in the image area 60. Next, the image area 60 in which the speckle noise is reduced is scanned as a whole while rotating the parallel plate 72 ((b) of FIG. 10). During this period, the laser light source is not lit in the image area 61. By scanning in this way, the amount of control for the actuator 71 and the parallel plate 72 in each frame becomes less, resulting in a higher reliability of the device.

As describe above, with the scanning type image display apparatus of the present invention's second embodiment, the speckle noise is effectively generated in a given image area by using a single laser light source. As a result, an image that catches attention of the viewer can be displayed easily while maintaining the small size and low cost of the apparatus.

The scan controlling section 44 may have the function of the light irradiation position control section 49. A mirror or an acoustooptic element may be used instead of the parallel plate 72. Further, means to temporally modulate driving electrical current of the laser light source 40 may be provided instead of the light irradiation position control section 49. The temperature of the semiconductor laser changes due to causes such as output, modulating frequency and modulating duty, and the wavelength changes as the temperature changes and the spectrum width becomes wider. When the spectrum width becomes wider, the speckle noise can be reduced since the coherency of the laser light becomes lower. By utilizing this feature, the semiconductor laser is modulated so that when the temperature change of the laser light source 40 is small in the image area 61 in which the speckle noise is generated, and the temperature change of the laser light source 40 is large in the image area 60 in which the speckle noise is reduced. In particular, when a semiconductor laser with 25% efficiency is driven at 1 W peak output and 120 Hz/33.3%, the spectrum width approximately doubles due to the temperature change.

### Third Embodiment

In the third embodiment, a case, which the laser light source 1 and 40 explained in the first and second embodiment, each comprise three laser light sources; a red laser light source, a blue laser light source and a green laser light source, is explained.

Of the three primary colors required to display a color image, an efficient semiconductor laser for the green color has not been developed yet. Therefore a case will be describe in which semiconductor laser is used as each of the red and blue laser light sources, and a wavelength conversion laser obtained by converting the wavelength of a infrared light into a green light is used as a green laser light source. When a semiconductor laser that outputs an infrared wavelength of 1064 nm is the light source, and a laser light outputted from this light source is inputted in a nonlinear crystal that has a polarization inversion structure, a green laser light with a wavelength of 532 nm can be obtained as a second harmonic.

The spectrum width of the green laser light obtained by such wavelength conversion is smaller than the spectrum width of the red and the blue laser lights outputted from the semiconductor lasers. This is because the spectrum width of the nonlinear crystal that can convert wavelength is smaller than a gain region of the semiconductor laser. The green laser light with a small spectrum width has a higher coherency than the red and blue laser lights and has a larger speckle noise. As a result, the speckle noise of a green light component has the greatest effect on the speckle noise strength of the whole image display apparatus. Furthermore, the viewer perceives the green laser light brighter since it has a higher luminosity factor than the red and blue laser lights.

Therefore it can be said that the speckle noise of the green light component stands out more than the speckle noises of the red and blue light component. As a result, in an image display apparatus that has three laser light sources for red, blue and green, it is only necessary to deal with the speckle noise of the green light component as a subject that needs to be controlled. By doing in such way, cost of the image display apparatus can be reduced.

Although details of the present invention were explained hereinbefore, the explanations are only examples of the present invention in every aspect, and they are not aimed to limit the invention in any ways. Not to mention that various improvements and variations can be made as long as they are within the scope of the present invention.

What is claimed is:

1. An image display apparatus that utilizes a speckle noise specific to a laser light, the image display apparatus comprising:
a laser light source;
a spatial modulation element operable to convert a laser light outputted from the laser light source into an image; and
a light passing control section operable to control, in each of a predefined image area, a scatter pattern generated when the laser light passes through.

2. The image display apparatus according to claim 1, wherein:
the light passing control section is a planar device having a plurality of cells arranged in a grid pattern, the plurality of cells are each filled with a fluid having charged particles dispersed therewithin; and
the light passing control section individually controls a voltage applied to the plurality of cells so that, the scatter pattern is altered in an image area in which the speckle noise is reduced, and the scatter pattern is not altered in an image area in which the speckle noise is generated.

3. The image display apparatus according to claim 2, wherein the voltage is applied at a frequency of 30 Hz or more.

4. The image display apparatus according to claim 1, wherein:
the light passing control section is a planar device having a plurality of cells arranged in a grid pattern, the plurality of cells are each filled with a liquid crystal; and
the light passing control section individually controls a voltage applied to the plurality of cells so that, the scatter pattern is altered in an image area in which the speckle noise is reduced, and the scatter pattern is not altered in an image area in which the speckle noise is generated.

5. The image display apparatus according to claim 4, wherein the voltage is applied at a frequency of 30 Hz or more.

6. The image display apparatus according to claim 1, wherein:
the light passing control section is a planar device having a plurality of cells arranged in a grid pattern, the plurality of cells are each filled with a fluid having ferromagnetic particles dispersed therewithin; and
the light passing control section individually controls a magnetic field applied to the plurality of cells so that, the scatter pattern is altered in an image area in which the speckle noise is reduced, and the scatter pattern is not altered in an image area in which the speckle noise is generated.

7. The image display apparatus according to claim 6, wherein the magnetic field is applied at a frequency of 30 Hz or more.

8. The image display apparatus according to claim 2, wherein,
in a displayed image, one cell among the plurality of cells is allocated to correspond to a set of neighboring three pixels, these pixels being red, blue and green.

9. The image display apparatus according to claim 4, wherein,
in a displayed image, one cell among the plurality of cells is allocated to correspond to a set of neighboring three pixels, these pixels being red, blue and green.

10. The image display apparatus according to claim 6, wherein,
in a displayed image, one cell among the plurality of cells is allocated to correspond to a set of neighboring three pixels, these pixels being red, blue and green.

11. The image display apparatus according to claim 1, wherein;
the laser light source includes three laser light sources, for red, blue and green, respectively; and
the light passing control section controls the speckle noise only for the green light component.

12. A scanning type image display apparatus that utilizes a speckle noise specific to a laser light, the scanning type image display apparatus comprising:
a laser light source;
a power control section operable to control a power of a laser light outputted from the laser light source;
a scan controlling section operable to scan the laser light controlled by the power control section and convert the laser light to an image on a projection plane; and
a light irradiation position control section positioned at a point between the laser light source and the projection plane, which is operable to control where the laser light is emitted on the projection plane, individually in each predefined image area.

13. The image display apparatus according to claim 12, wherein;
the light irradiation position control section individually controls the scanned laser light, in a manner that shifts the center of the emitted laser light for every scan in an image area on the projection plane in which the speckle noise is reduced, and in a manner that fixes the center of the emitted laser light in an image area on the projection plane in which the speckle noise is generated.

14. The image display apparatus according to claim 13, wherein;
the scan controlling section scans the image area in which the speckle noise is generated first, and then scans the image area in which the speckle noise is reduced next, in one screen.

15. The image display apparatus according to claim 12, wherein;
the laser light source includes three laser light sources, for red, blue and green, respectively; and
the light irradiation position control section controls the speckle noise only for the green light component.
